(19) United States
(12) Patent Application Publication
(10) Pub. No.: US 2003/0236007 A1
(43) Pub. Date: Dec. 25, 2003

(54) Connector for an electronic component

(76) Inventors: Poh Huat Lye, Penang (MY); Ak Wing Leong, Penang (MY)

Correspondence Address: AGILENT TECHNOLOGIES, INC, Legal Department, DL429, Intellectual Property Administration, P.O. Box 7599, Loveland, CO, 80537-0599, US

(21) Appl. No.: 10/424,235

(22) Filed: Apr. 28, 2003

(30) Foreign Application Priority Data
Jun. 25, 2002 (MY) PI20022387

(51) Int. Cl. H01R 12/00

(52) U.S. Cl. 439/71

(57) ABSTRACT

A connector for an electronic or an optoelectronic component which is plug-in connected to a connecting part of an electrical device, comprising a supporting body which has a receiving recess for receiving the connecting part, the recess being open toward the outside. Further, the connector comprises an electronic or an optoelectronic component which is arranged on the supporting body, and at least one lead which is connected to the electronic or the optoelectronic component and extending therefrom into the recess, wherein an end section of the lead extends into the recess and forms a terminal for being connected to a corresponding terminal of the connecting part received within the recess. Further, a circuit board system comprises a circuit board having an edge on which a terminal is arranged to which the connector is connected.

### FIELD OF THE INVENTION

This invention is in the field of electronic technology and relates to a connector for an electronic or an optoelectronic component for connecting to a circuit board or a cable.

### BACKGROUND OF THE INVENTION

In general, circuit boards, for example printed circuit boards (PCB's), consist of various electronic and/or optoelectronic components, in particular silicon chips with integrated circuits. The arrangement of the chips on the circuit boards is influenced for example by conductive traces, accessibility of the chips, or other geometrical or functional reasons. Also, the practicability and the feasibility of an assembling process in an automatic assembly machine plays an important role.

It is generally known from prior art that the chips are installed on the circuit board by connecting chip leads directly to conductive traces by soldering. It is an advantage of this method that the total number of components is relatively low. However, in case of repair this method does not allow easy replacement of the chips installed on a circuit board once the chip leads are soldered. Additionally, all components adjacent to a soldering joint are exposed to high temperature during the soldering process. Since semiconductor components like chips are susceptible to high temperature influence, the reliability of the components could be reduced, or the components could even be destroyed. Furthermore, material with low melting points located adjacent to the soldering joint, for example plastic materials, can be affected by the heat occurring during soldering so that only heat-resisting materials should be used.

Another technique generally known from prior art is to solder a connector to the circuit board into which the relevant chip is plugged. It is an advantage of this plug-in method that the chip is not affected by heat during the soldering process since the chip is only installed once the soldering process has been finished. However, the total number of components is relatively high and the procedure is relatively costly.

### SUMMARY OF THE INVENTION

According to a first aspect of the present invention there is provided a connector for an electronic or an optoelectronic component which is plug-in connected to a connecting part of an electrical device, comprising a supporting body which has a receiving recess for receiving the connecting part, the recess being open toward the outside. Further, the connector comprises an electronic or an optoelectronic component which is arranged on the supporting body, and at least one lead which is connected to the electronic or the optoelectronic component and extending therefrom into the recess, wherein an end section of the lead extends into the recess and forms a terminal for being connected to a corresponding terminal of the connecting part received within the recess.

According to a second aspect of the present invention there is provided a corresponding circuit board system comprising a circuit board having an edge on which a terminal is arranged to which the connector is connected.

### BRIEF DESCRIPTION OF THE DRAWINGS

In the following the invention is explained with reference to embodiments represented in the drawings, wherein

FIG. 1 is a top view of a first embodiment of the connector,

FIG. 2 is a sectional view along the dotted line in FIG. 1 of the first embodiment of the connector,

FIG. 3 is a front view of the first embodiment of the connector,

FIG. 4 and FIG. 5 show side views of the first embodiment of the connector,

FIG. 6 is a bottom view of the first embodiment of the connector,

FIG. 7 shows isometric views of the first embodiment of the connector,

FIG. 8 shows a top view of a second embodiment of the connector,

FIG. 9 is a sectional view along the dotted line in FIG. 8 of the second embodiment of the connector,

FIG. 10 is a front view of the second embodiment of the connector,

FIG. 11 and FIG. 12 show side views of the second embodiment of the connector,

FIG. 13 is a bottom view of the second embodiment of the connector,

FIG. 14 shows isometric views of the second embodiment of the connector,

FIG. 15 shows a top view of a third embodiment of the connector,

FIG. 16 is a sectional view along the dotted line in FIG. 15 of the third embodiment of the connector,

FIG. 17 is a front view of the third embodiment of the connector,

FIG. 18 and FIG. 19 show side views of the third embodiment of the connector,

FIG. 20 is a bottom view of the third embodiment of the connector,

FIG. 21 shows isometric views of the third embodiment of the connector,

FIG. 22 shows an isometric view of the connector according to the first embodiment arranged so as to be plug-in connected to a circuit board terminal, and

FIG. 23 shows an isometric view of the connector according to the first embodiment plug-in connected to the circuit board terminal.

### DETAILED DESCRIPTION OF PREFERRED EMBODIMENTS OF THE INVENTION

A connector and circuit board system in accordance with the invention has the advantage that it can make use of a simple and economical assembling procedure for an installation of an electronic or an optoelectronic component on a circuit board, whereby all components involved maintain their high reliability even when low-cost materials are used.

According to the invention, the connector comprises the supporting body on which the electronic or the optoelectronic component, as in particular a chip having an integrated circuit, is arranged and the leads connected to the terminals of the component. Consequently, the connector forms a single unit because all parts of the connector are fixed together. The installation of the single unit connector at the circuit board terminal can be directly performed because no additional connector is necessary. Further, the handling of a single unit connector is more simple than the handling of a component consisting of several parts. This is applicable to the assembling procedure or to stock-keeping of spare parts, for example.

The end section of each lead extending into the recess forms, together with the recess, the terminal of the connector. The terminal is of a plug-in type so that for installation purposes the connector has to be plugged-in at the corresponding circuit board terminal. This simple installation method can be performed directly because no additional processing, for example soldering, is required. This results in a reduction of cost and time of the assembling procedure of the circuit board. Further, since the soldering has been omitted during the installation procedure, relevant components are exposed to ambient temperature only during the installation of the connector. This is advantageous because the exposure to high temperature, occurring during soldering, would affect the reliability of, for instance, semiconductor components and would increase their failure rate, which can be avoided here. As a consequence, the rate of defects of the circuit boards after assembly and therefore the production cost per circuit board can be reduced by using the inventive connector. Due to the lack of the exposure to high temperature, non heat-resisting material, for example low melting-point plastics, can be used for all relevant parts. Since heat-resisting material is more costly than non heat-resisting material, material cost is reduced, too.

The installed connector is located at an edge of the circuit board provided with relevant terminals. Hence, the face of the circuit board is clear of, for instance, chips. Therefore, the inventive connector is also applicable for flexible circuit boards. However, chips installed on the face of the flexible circuit board could be destroyed due to stress caused by bending. The inventive connector is also applicable for flexible cable ends, in case relevant terminals are provided. Circuit boards in circuit cards are often arranged in parallel inside electronic devices, so that only the edges of the circuit cards are accessible without disassembling the electronic device. Therefore, the edge installation of the connector is advantageous due to the high accessibility of the circuit board terminals for the end user. A replacement of the connector, for example caused by a defective chip, can be performed simply and quickly without any disassembling procedure becoming necessary.

The component can be attached to the supporting body by means of a glued joint between the component casing and the surface of the supporting body, for example. It is a preferred embodiment of the invention that the component is integral within the supporting body. I.e., the component can be integral cast or molded into the supporting body, for example, or the component can be embedded in a cavity of the supporting body. Said cavity can be filled with clear or colored opaque compound or covered with a lid. It is an advantage of an integral component arrangement that the component is protected against harmful or destructive effects from the outside. These can be mechanical impacts which can destroy the component casing or the component pins. Further, the component pins and the component casing are protected against corrosive or acrid environment.

Preferably, the supporting body is made of plastic material. For example, the plastic material has an opaque color. In case the component includes an optoelectronic element, it is a preferred embodiment of the invention that the supporting body is made of clear plastic with an adequate optical characteristic so that the inventive connector is appropriate for optical applications.

The section of the lead between the end connected to the component terminal, and the end located within the recess, is located outside the supporting body according to a preferred embodiment of the invention. This arrangement is simple and therefore of low manufacturing costs. Another advantage is that the component terminals are indirectly accessible via the lead sections for possible electronic measurements during operation of the component. However, in case the component pins, or the leads respectively, must be protected from touching in order to prevent destructive electrostatic charging of the component, the leads may be covered with an insulator. Therefore, it is a preferred embodiment of the invention to integrally cast or mold the lead sections into the supporting body. Thereby, protection against dust, mechanical influence, corrosive or acrid environment is also given.

For example, the lead end sections, located within the recess, can be formed straight like a pin. However, it is a preferred embodiment of the invention that the end sections are arc-shaped so that they form elastically deformable elements. For this reason a self-clamping joint fixes the installed connector to the circuit board terminal, no additional fixation devices being necessary. Additionally, besides a good mechanical connection performed by elastically deformable lead ends, a good electrical contact at contact points is provided.

It is a preferred embodiment of the connector, having the slot type recess, which is advantageous, because the slot type recess has a guiding function when inserting the connector onto the circuit board terminal. Preferably, the lead end sections extend in parallel to each other and are arranged side-by-side along the recess. The preferred extension direction of the lead end sections is from the outside into the recess. The reason for this is, that the end section of the leads do not get jammed when inserting the connector onto the circuit terminal board.

Preferably, the lead end sections are arranged adjacent to the long sides of the recess. The arrangement on one long side of the recess is a preferred embodiment only in case that the circuit board terminal, which is to be connected, is printed on one side. In case the circuit board terminal is printed on both sides, an arrangement of the lead end sections is preferred where one portion is adjacent to one long side of the recess and the other portion is adjacent to the other long side of the recess. Then, both sides of the circuit board terminal can be used for the electronic connection.

In general, the shape of the supporting body is arbitrary. However, preferred is a block shaped supporting body, because it provides a space-saving arrangement of the chip and the recess terminal.

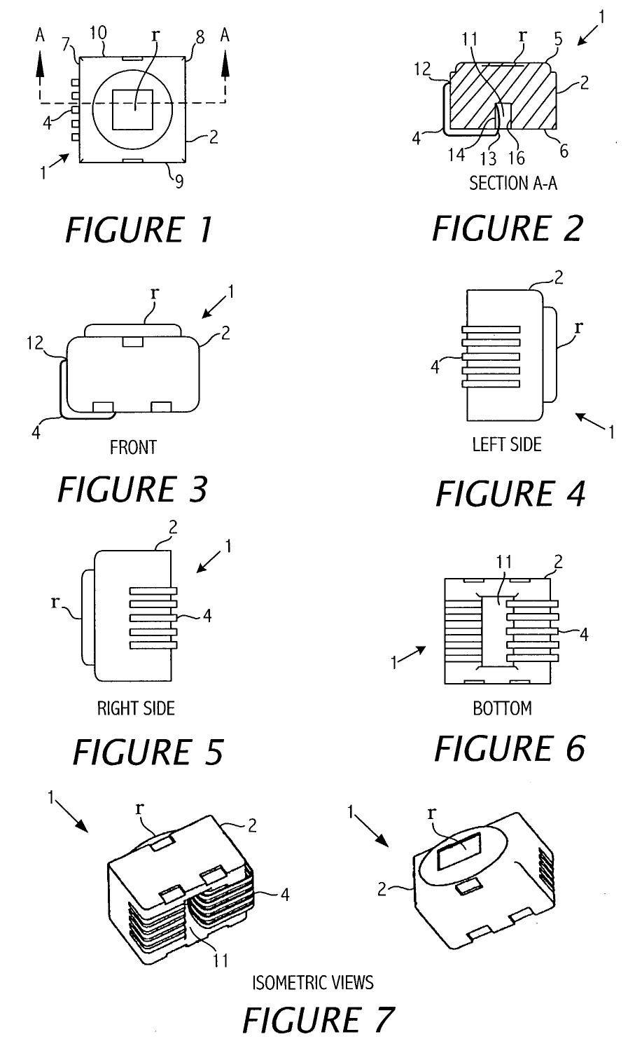

FIGS. 1-7 show a first possible embodiment of the invention. A connector 1 for an electronic or an optoelectronic component comprises a supporting body 2, an electronic or an optoelectronic component (not shown), and leads 4.

The supporting body 2 is of a block-type and comprises a top 5, a bottom 6, a left side 7, a right side 8, a front side 9 and a rear side 10. All sides 5, 6, 7, 8, 9 and 10 of the supporting body 2 are almost flat and the bottom 6 comprises a centered recess 11. The supporting body 2 is typically made of plastic material. The use of plastic material has the advantage that it is inexpensive and the manufacturing process is simple so that the supporting body 2 can be manufactured in high numbers at a low cost. Further, the plastic material has insulating characteristics so that conductive components can be arranged on or within the supporting body 2 without taking any additional shielding measures. Further, the plastic material has a relative low melting point, which prevents damaging for instance semiconductor components during the integral casting/molding process.

The electronic or the optoelectronic component is fully integrally cast/molded within the supporting body 2. This is the reason why the component cannot be identified directly in FIG. 1, because only the supporting body 2 is shown. The component is integrated in the top region of the supporting body 2 and the lengthwise orientation of component terminals or pins is towards the bottom 6 of the supporting body 2. Therefore, the pins of the component are inside the plastic supporting body 2. Consequently, the component is fully protected from the outside and its pins are fully insulated.

The leads 4 comprise a conductive material formed into oblong strips. One end 12 of each lead is integrally cast/molded within the supporting body 2 and connected to the relevant component pin. The direction of the lead ends 12 is horizontal within the supporting body 2, provided that the connector orientation is as shown in FIG. 2. Further, the lead ends 12 are lead away from the component towards the outside of the supporting body 2. This is the reason why crossing points, i.e. short cuts, of the lead ends 12 are avoided inside the supporting body 2. The leads 4 are arranged side-by-side so that a pin arrangement structure of the component pins is maintained.

The remaining portion of each lead 4 outside the supporting body 2 runs almost parallel to the supporting body surface toward the bottom side 6 of the supporting body 2. The embodiment according to FIGS. 1-7 comprises the leads 4, arranged on one side of the supporting body 2 only, here on the left side 7 of the supporting body 2. Therefore, this embodiment can be applied in combination with a circuit board terminal, printed on one side only. In case the component, for instance a chip with an integrated circuit, has two parallel pin rows, it is a preferred embodiment that the component is arranged within the supporting body 2, so that the pin rows of the component run parallel to the left side 7 of the supporting body 2.

Bottom 6 of the supporting body 2 comprises the centered recess 11 which preferably has an elongated rectangular shape. Recess 11 extends parallel to the left side 7 of the supporting body 2. In a cross sectional plane, cutting the recess 11 vertically, recess 11 has a rectangular cross section area, as shown in FIG. 2. Recess 11 forms a frame of a terminal which is plug-in connected to the respective terminal on the circuit board. It is a preferred embodiment that recess 11 forms a pocket which is deeper than it is wide. Thus, recess 11 provides both good guiding characteristics for slipping on connector 1 and a high fixing stability.

The leads 4 are lead from the bottom side 6 of the supporting body 2 into the recess 11. In recess 11 lead end sections 13 have an arched shape. Therefore, the end sections 13 have a spring effect when forced against a long side 14 of the recess 11. This clamping effect is used when a circuit board terminal 15 is arranged within recess 11 for plug-in connection as shown schematically in FIG. 23.

In case the component includes an optoelectronic element for an optoelectronic application, the supporting body 2 is made of clear plastic with an adequate optical characteristic and the surface of the top 5 of the supporting body 2 is provided with a section comprising a mirror polish optical surface. This optical surface is located inside a shallow recess r in order to protect the optical surface from handling damage or handling scratches. The optoelectronic component may be a sensing component, such as a photodetector or a camera sensor. The optoelectronic component may also be an emitting component, such as an light emitting diode or a laser diode.

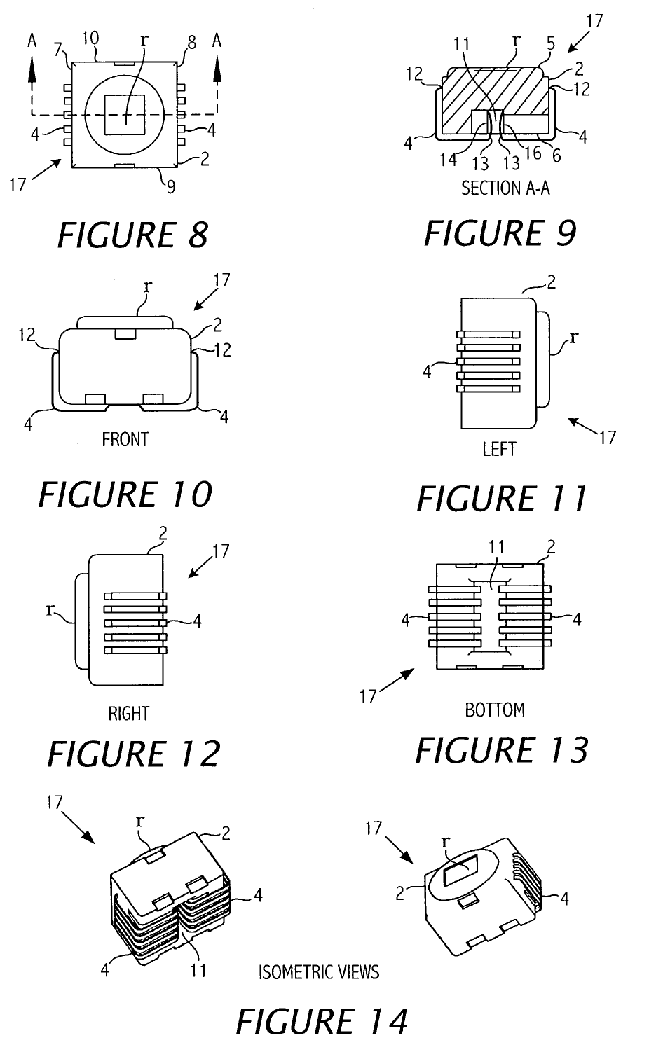

FIGS. 8-14 show a second embodiment of the invention, a connector 17 for an electronic or an optoelectronic component. This embodiment is similar to the first embodiment shown in FIGS. 1-7. Contrary to the first embodiment, which comprises the leads 4 arranged on the left side 7 of the supporting body 2 only, the second embodiment has leads 4 arranged on the left and the right side 7 and 8 of the supporting body 2 and on the left and the right long side 14 and 16 of recess 11. Therefore, the second embodiment can be applied in combination with circuit board terminals printed on both sides. For better guiding characteristics of the connector 17, when being slipped onto the circuit board terminal, a portion of lead end sections, arranged within recess 11 adjacent to the right long side 16, are mirror-inverted to a portion of lead end sections, arranged adjacent to the left long side 14.

In case the component has many pins to be connected to the circuit board terminal, the second embodiment of the invention is more advantageous compared to the first embodiment, because an arrangement of leads 4 on both sides of the supporting body 2 according to the second embodiment provides a space-saving construction and design of the inventive connector 17.

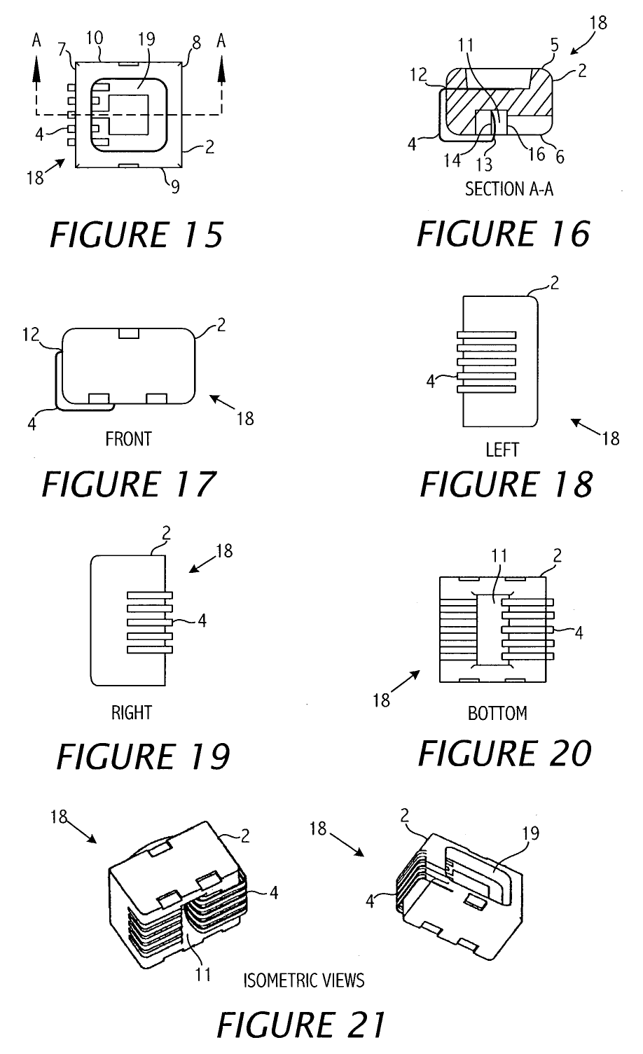

A third embodiment of a connector 18 for an electronic or an optoelectronic component is shown in FIGS. 15-21. Compared to the first embodiment, the third embodiment comprises a cavity 19 on top 5 of the supporting body 2. Cavity 19 has a rectangular shape so that the casing of the component, for instance of a chip with an integrated circuit, can be fit in. Cavity 19 is designed to embed the component for fixing and protecting it against outside effects. The lengthwise orientation of the pins of the component is towards the bottom 6 of the supporting body 2. Thus, the arrangement of the leads 4 within the supporting body 2 is similar to the lead arrangement of the first embodiment.

Although the third embodiment comprises the leads 4 on the left side 7 of the supporting body 2 only, it is conceivable to arrange the leads 4 on both sides 7, 8 of the supporting body 2 as per the second embodiment. Therefore, the third embodiment is applicable in combination with circuit board terminals printed on one side only and with circuit board terminals printed on both sides.

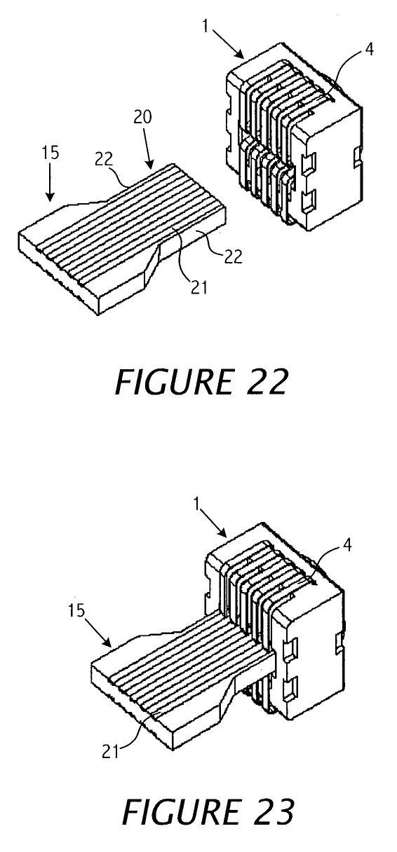

FIG. 22 shows the connector 1 according to the first embodiment of the invention arranged so as to be plug-in connected to the circuit board terminal 15. FIG. 23 shows the embodiment shown in FIG. 22, but the connector 1 is plug-in connected to the circuit board terminal 15.

The circuit board terminal 15 comprises a flat edge projection 20 of the circuit board wherein the projection 20 has strip conductors 21 arranged in parallel to each other so as to represent an arrangement structure of the leads 4 on the circuit board terminal 15. By virtue of the parallel structure of the strip conductors 21 on the circuit board terminal 15 the plug-in connection can be performed without risking a short circuit or a bad connection of the leads 4.

It is preferred that the geometry of the recess 11 and of the circuit board terminal 15 is matched so that a plug-in connection with high stability can be performed. I.e., the length of the recess 11 is adapted to the width of the projection 20 and the width of the recess 11 is adapted to the thickness of the projection 20 in order to generate a mechanical stable connection without easy tilting or shifting the connector 1. For increasing stability the recess 11 in the supporting body 2 is formed as a pocket so that the projection 20 is embedded all over by the supporting body 2.

Further, when slipping the connector 1 on the circuit board terminal 15, the guiding and fixation function of flanks 22 of the projection prevents a mismatching between the leads 4 and the strip conductors 21.

The position of the connector 1 on the edge of a circuit board terminal 15 is particularly advantageous when the component of the connector 1 is an optoelectronic component, and the circuit board and connector 1 are contained in a housing of an electronic device. The optoelectronic component is positioned so as to face away from the circuit board. A window in the housing of the electronic device would thus enable the optoelectronic component to communicate through the window in a direction parallel with the plane of the circuit board. For example, the optoelectronic component could be a camera sensor and the electronic device could be a mobile telephone containing a planar circuit board with the connector attached at the end of the circuit board.

Although the present invention and its advantages have been described in detail, it should be understood that various changes, substitutions and alterations can be made herein without departing from the spirit and scope of the invention as defined by the appended claims. For example, it is apparent that the term electronic components includes optoelectronic components.

What is claimed is:

1. A connector for connecting an electronic component to a connecting part of an electrical device, comprising:
a supporting body which has a receiving recess for receiving the connecting part;
an electronic component supported by the supporting body;
and at least one lead connected to the electronic component, extending outside the supporting body and into the recess, wherein an end portion of the lead extends into the recess and forms a terminal for connection to a corresponding terminal of the connecting part received within the recess.

2. The connector according to claim 1, wherein the recess is an elongated slot, and a plurality of leads are arranged along a long side of the recess.

3. The connector according to claim 1, wherein the recess is an elongated slot, and a plurality of leads are arranged along both long sides of the recess.

4. The connector according to claim 1, wherein the supporting body comprises clear plastic.

5. The connector according to claim 1, wherein the electronic component is integrally molded into the supporting body.

6. The connector according to claim 1, wherein the supporting body comprises a cavity in which the electronic component is embedded.

7. The connector according to claim 6, wherein the cavity is filled with a clear or colored opaque compound.

8. The connector according to claim 6, wherein the cavity is covered with a lid.
